(19) United States
(12) Patent Application Publication
(10) Pub. No.: US 2005/0256927 A1
(43) Pub. Date: Nov. 17, 2005

(54) System and method for direct communication between automation appliances

(76) Inventor: Michael Schlereth, Wilhermsdorf (DE)

Correspondence Address: Siemens Corporation;Intellectual Property Department, 170 Wood Avenue South, Iselin, NJ, 08830, US

(21) Appl. No.: 10/519,627

(22) PCT Filed: Jun. 20, 2003
(86) PCT No.: PCT/DE03/02067

§ 371 Date: Dec. 28, 2004

(30) Foreign Application Priority Data
Jul. 2, 2002 (DE) 102 29 636.7

(51) Int. Cl. G06F 15/16

(52) U.S. Cl. 709/206

(57) ABSTRACT

The invention relates to a system and a method for communication between automation appliances. According to the invention, peer-to-peer communication over the Intranet or Internet is carried out, enabling a direct exchange of information between the automation appliances. Each automation appliance is used to send a request via the data transmission system to all other automation appliances known to the same. All of the automation appliances are used to forward a received request to all other automation appliances known thereto.

### CROSS REFERENCE TO RELATED APPLICATIONS

This application is the U.S. National Stage of International Application No. PCT/DE2003/002067, filed Jun. 20, 2003 and claims the benefit thereof. The International Application claims the benefits of German application No. 10229636.7 filed Jul. 2, 2002, both applications are incorporated by reference herein in their entirety.

### FIELD OF THE INVENTION

The invention relates to a system and a method for communication and/or transmission of information between automation devices via a data transmission system.

### BACKGROUND OF THE INVENTION

The automation devices which are located on a site, in particular control devices such as stored programmable controls or digital controls but also display devices such as operator panels, normally exchange messages or information with each other. To this end, the automation devices today are connected to each other via networks, in particular field bus systems. In this context, the communication between the participating automation devices takes place via so-called protocols, i.e. descriptions of how the participating devices communicate with each other. In the case of the bus systems which are used today, use is made of so-called proprietary protocols which are not based on a standard. The communication between the participating automation devices normally takes place via central data processing units, which are likewise connected to the bus system and which forward incoming messages or information from the automation devices to the relevant addressees.

DE 100 38 557 A1 discloses a system and a method for transmitting data via data networks, in particular via an Internet with asynchronous data connection. In this context, a so-called client-server connection via a permanently open data connection makes it possible to send data from the server to the client at any time, independently of actions of the client.

A method for communicating between Web users is disclosed in Marmor, M. S. “make the P2P leap with toadnode” Web Techniques, Miller Freeman, US Volume 5, Number 12, December 2000, pages 44-49, in which requests are submitted to computers which are present in the web, and these computers make their data available to the requesting web user by transmitting it directly to the Web user's computer. Any use of servers for data transmission is not required in this type of configuration.

WO 01/50684 discloses a method and a system for the distributed control of a “home automation” system. In this context, a status change of a device is sent to all other devices which are participating in the system. These recipients check whether the change which is contained in the message is relevant and react accordingly.

### SUMMARY OF THE INVENTION

The invention addresses the problem of specifying a system and a method whereby the information exchange can be bidirectional between the participating automation devices, and whereby the communication can be initiated by any of the participating automation devices.

This object is achieved by a system for communication and/or transmission of information between automation devices via a data transmission system, wherein an automation device which participates in the system has means for sending and/or receiving requests and/or replies, and wherein the means are used for direct communication and/or transmission of information between the automation devices. The invention is based on the perception that the automation devices on a site today satisfy increasingly complex tasks. Consequently, the automation devices also require increasing amounts of information, in particular information from other automation devices which are present on the site, in order to be capable of properly performing their function. The required data includes e.g. process values from a site, but also messages, alarms or whole programs or software components which an automation device requires for executing a task. Therefore the exchange of information between the automation devices on a site is becoming increasingly important. Maximum benefit is naturally gained if partners participating in a communication, said partners being the automation devices in this case, can send the information which is required for the communication directly to the relevant recipient or, if information is needed, can submit requests directly to other participating partners. Collection and management of requests and replies at a central point, e.g. on a data processing device, would delay the flow of information and generate unnecessary management burdens. Therefore the system according to the invention for communication is evidently advantageous since the participating communication partners, i.e. the automation devices, can communicate directly with each other and the requested information can also be sent directly from one of the participating automation devices to the automation device which originally submitted the request. Using a direct communication such as this, each of the participants can both collect information and make information available.

A further advantageous development of the invention is characterized in that the means are used for peer-to-peer communication between the automation devices. Using this form of communication, each device is independently able to both collect information and make information available. In this type of configuration, little management burden is generated and it is possible dynamically to include or exclude communication participants. Such a form of communication generally reduces time and costs which are required for the exchange of information.

A further advantageous development of the invention is characterized in that the data transmission system is developed as an Intranet and/or Internet. The advantage of this development is that the connection of the automation devices takes place over a standard network, in particular a TCP/IP network. A standard protocol, namely the HTTP protocol for information transmission, can therefore be used for the communication between the participating devices. In this way, implementation and operation of the communication system is simplified because it is not necessary to use specific proprietary protocols for communication.

A further advantageous development of the invention is characterized in that the means for sending and/or receiving are developed as a basic service of an operating system for communication. Consequently, there is no need to implement specific interfaces for the transmission of information and communication between the automation devices. Engineering of the site and commissioning of the automation devices within the communication system are both significantly simplified and improved as a result of this advantageous development of the invention. Standardized HTTP sockets such as the socket 80, for example, can be used as basic services which are provided by the operating system. The use of these interfaces results in a significant improvement of the communication system, since the standardized interfaces are cheaper than specific connections which still have to be programmed. The use of the standard within the communication system also provides a simplification, in that adapting the communication system by adding further automation devices is also easy to perform in the future, since there is no danger that specific communication protocols which are only used for a particular application will become obsolete.

The use of HTTP sockets as a basic service of an operating system also has the advantage that an automation device on a corresponding socket can both wait for incoming requests and initiate requests to other automation devices via the corresponding socket. Therefore only one single interface is required for the sending and receiving of information or requests.

A further advantageous development of the invention is characterized in that each automation device is used for sending a request via the data transmission system to all other automation devices of which it has knowledge. Therefore if an automation device which is present in the system requires information such as e.g. process values or programs which could possibly be provided by other automation devices, the automation device uses its send and receive facility to initiate a request via the Intranet or Internet to all the other devices which it knows to be present in the system. The advantage in this development according to the invention is that an automation device is not obliged to send its request to a central location where the request must be managed, as this could possibly result in a loss of the request if the central data processing device is not operating correctly. The responsibility for the request therefore lies with the automation device itself in this case, and as many other participating partners as possible are asked within the shortest time whether they have information and can provide information if applicable.

A further advantageous development of the invention is characterized in that all automation devices are used for forwarding a request which arrives via the sending and/or receiving means to all other automation devices of which they have knowledge, which have not yet received the request. The advantage in this development is that the request which is sent from an originating automation device is not forwarded exclusively to the other automation devices which it knows within the system, and instead many other automation devices learn of the request via a type of snowball system. In this way, the circle of partners participating in the communication expands dynamically, and the probability of the automation device which submitted the request receiving a reply or the information it desires increases.

A further advantageous development of the invention is characterized in that the automation devices are used for sending an address to the automation device which submitted the request. If a device within the system finds that it possesses information which is relevant for the automation device which submitted the original request, it can send a notification in this simple way, said notification specifying the address at which it can be reached within the communication system. The automation device thus makes itself known directly to the original automation device which submitted the request. This has the advantage that the automation device which submitted the request knows exactly where to find the information it requires.

A further advantageous development of the invention is characterized in that the means for sending and/or receiving on the automation devices are used for direct collection from automation devices which make information available at the address which has been sent. The main advantage here is that the information is not sent via further data processing facilities which are present in the system, but that a direct information exchange takes place instead between the participating automation devices in the system. Storage space, particularly on a potential data processing facility, and time during information transmission are both saved as a result of this. The utilization of the direct route through the data transmission system is clearly advantageous in terms of high efficiency, since unnecessary data transmission and unnecessary extended routes within the data transmission system are avoided.

A further advantageous development of the invention is characterized in that the request has means for canceling its forwarding through the automation devices on the basis of a time limit. Therefore a request which is made by an automation device to all further participants within the system does not necessarily live for ever if none of the participants within the system is able to make information available; the request is instead deleted following the expiry of a defined time unit, i.e. it dies and therefore causes no further data exchange between the participating devices within the system. This advantageous development therefore ensures that the system is not brought to a standstill over time by excessive data volumes due to circulating requests which are sent back and forth between the participating devices. If the required information is not found within a reasonable time unit, it is highly probable that the information is not present in the participating communication participants in any case, and the demise of the original request is an advantageous solution for avoiding unnecessary data transfer.

A further advantageous development of the invention is characterized in that a device is provided for managing the addresses of the participating automation devices, said device being connected to the data transmission system. According to this development according to the invention, provision is made for connecting a server to the data transmission system, wherein said server then manages all the devices in the system with reference to their addresses. Instead of request forwarding via the snowball system as described above, forwarding of the requests would in this case be given to the index server, which for its part then forwards the request to the automation devices of which it has knowledge. All participating automation devices in the system would therefore receive the search request directly via the server without further intermediate stages. Any time delay resulting from a plurality of automation devices being connected in series would be eliminated in the case of this advantageous development of the invention.

### BRIEF DESCRIPTION OF THE DRAWINGS

The invention is described and explained in greater detail below with reference to the exemplary embodiments which are illustrated in the figures, in which:

FIG. 1 shows a schematic illustration of a system for the communication and/or transmission of information between automation devices via a data transmission system,

FIG. 2 shows a schematic illustration of the procedure of a communication or information provision between the participating automation devices in the system.

### DETAILED DESCRIPTION OF THE INVENTION

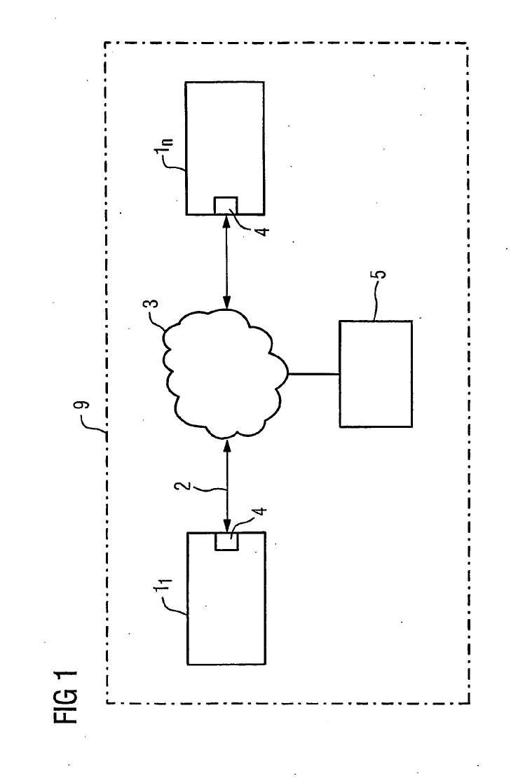

FIG. 1 shows an illustration of the system 9, in which the participating automation devices 1_{1 . . . n} communicate via a data transmission system 2. The data transmission system 2 is developed as an Intranet and/or Internet 3. The connection between the participating automation devices 1_{1 . . . n} and the data transmission system 2 takes place using means for sending and/or receiving 4, which means are located on the automation devices. A device 5 for address management of the automation devices 1_{1 . . . n} is connected to the data transmission system 2.

The particularity of the system 9 as illustrated in FIG. 1 is primarily that the automation devices 1_{1 . . . n} which are present in the system 9 can send or receive requests and information at any time via the data transmission system 2, to all other automation devices 1_{1 . . . n} which are present in the system 9, using the means 4 for sending and receiving information. The information which is required by the automation devices 1_{1 . . . n} or the requests which are sent by the automation devices 1_{1 . . . n} do not have to be sent via a central data processing facility and managed there, as would normally be the case. Instead, the automation devices 1_{1 . . . n} communicate directly with each other via the Intranet and/or Internet 3. Any time delay which results from the processing of information on a data processing facility is avoided by means of this direct communication. The automation devices can process their requests via the means 4 for sending and receiving with the aid of two different methods. In accordance with the HTTP protocol being used on the means 4 for sending and/or receiving which are developed in the form of an HTTP socket, the automation device can collect information from another automation device, wherein the HTTP Get method is used, as well as transmit information to another automation device, wherein the HTTP Post/Put method is used, on the same socket. Therefore only one interface is required for the information exchange. Together with the participating automation devices 1_{1 . . . n}, the data transmission system 2 which is illustrated in FIG. 1 represents a network in which the participating automation devices 1_{1 . . . n} are known with regard to their addresses. Furthermore, the overall system 9 represents a separate naming environment, i.e. an area in which defined entities and particularly data and programs can be addressed via a specific name. In this context, it is advantageous that all participating automation devices 1_{1 . . . n} are given the possibility of addressing required information using a name within the naming environment.

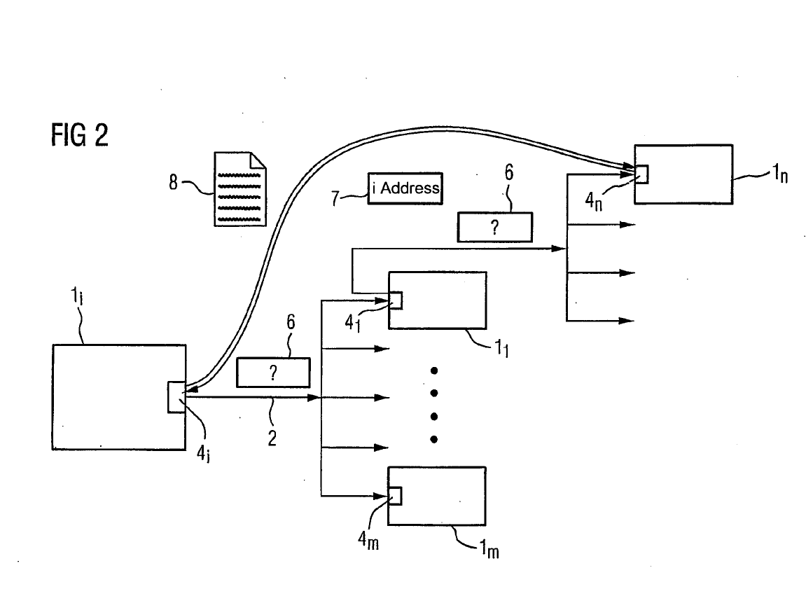

FIG. 2 shows a schematic illustration of the handling of requests 6 which are submitted by an automation device 1i and are forwarded by further automation devices 1_{1 . . . n}. Due to the forwarding of the requests 6, all automation devices 1_{1 . . . n} which are present in the system are eventually reached. If they possess the requested information, the automation devices 1_{1 . . . n} send their address 7 to the requesting automation device 1ᵢ. The requesting automation device collects the required information 8 directly from the automation device 1_{1 . . . n} which provides the information.

The advantage of handling the communication or the information exchange as illustrated in FIG. 2 is that all automation devices 1_{1 . . . n} which are present in the system (9) are made aware, by virtue of the request 6 which is designed as a search string, of the fact that the information is required. The request 6, which is formulated as a search string, can be implemented or interpreted differently by the participating automation devices 1_{1 . . . n} within the system 9. For example, one device can translate the string into a database query or another device can initiate a search in a text document. The searching device 1ᵢ is informed directly by the sending of an address 7 that the automation device which sends the address can provide the desired information. The direct sending of the address means that further intermediate steps within the data transmission system 2, which can naturally involve errors and produce data traffic, are unnecessary. The searching automation device 1ᵢ can collect the information 8 it desires directly from the automation device 1_{1 . . . n} via its means 4 for sending and receiving information 8. The form of information exchange or communication which is illustrated in FIG. 2 is particularly advantageous because it is characterized by a small administration burden, since the participating automation devices 1_{1 . . . n} can automatically log on to and log off from the data transmission system 2. Furthermore, this form of data exchange allows communication to be initiated by any device which is present in the system 9. Therefore, if an automation device 1 finds that it requires information, it can obtain it automatically.

In summary, the invention relates to the system 9 and a method for communication between automation devices 1 and for transmission of information between the automation devices 1. According to the invention, peer-to-peer communication via the Intranet or Internet 3 is used, thereby allowing a direct exchange of information between the automation devices 1.

1-27. (canceled)

28. A method for communication and/or transmission of information between automation devices via a data transmission system, the method comprising:
sending and/or receiving requests and/or replies by each participating automation device, wherein
the communication and/or transmission of information takes place directly between the automation devices; and
sending an address by the automation devices directly to the automation device which submits the request.

29. The method according to claim 28, wherein the communication between the automation devices takes place in the form of peer-to-peer communication.

30. The method according to claim 28, wherein the communication and/or transmission of information takes place via an Intranet and/or Internet.

31. The method according to claim 28, wherein communication takes place via a basic service of an operating system.

32. The method according to claim 28, wherein each automation device sends a request via the data transmission system to all other automation devices of which it has knowledge.

33. The method according to claim 28, wherein all automation devices forward a request, which arrives via sending and/or receiving mechanisms, to all other automation devices which it knows, and which have not yet received the request.

34. The method according to claim 28, wherein the automation devices directly collect information from automation devices which make information available at the address which has been sent.

35. The method according to claim 28, wherein the forwarding of the request through the automation devices is canceled on the basis of a time limit.

36. The method according to claim 28, wherein the addresses of the participating automation devices are managed by a device which is connected to the data transmission system.

37. An automation device for communicating with and/or transmitting information to and from further automation devices via a data transmission system, the automation device comprising:
mechanisms for sending and/or receiving requests and/or replies, wherein the mechanisms are adapted for direct communication and/or transmission of information between the automation devices, and wherein
the automation device is used for directly sending an address to an automation device which submits a request.

38. The automation device according to claim 37, wherein the mechanisms are used for peer-to-peer communication between the automation devices.

39. The automation device according to claim 37, wherein the mechanisms for sending and/or receiving are designed as a basic service of an operating system for communication.

40. The automation device according to claim 37, wherein the automation device is used for sending a request via the data transmission system to all other automation devices of which it has knowledge.

41. The automation device according to claim 37, wherein the automation device is adapted for forwarding a request, which arrives via the sending and/or receiving mechanisms, to all other automation devices which it knows, which have not yet received the request.

42. The automation device according to claim 37, wherein the mechanisms for sending and/or receiving are adapted for the direct collection of information from automation devices which make information available at the address which has been sent.

43. The automation device according to claim 37, wherein the request comprising a mechanisms for canceling its forwarding through the automation devices on the basis of a time limit.

44. An automation system comprising:
a data transmission system for communicating and/or transmitting information between automation devices; and
at least one automation device, the automation device comprising:
mechanisms for sending and/or receiving requests and/or replies, wherein the mechanisms are adapted for direct communication and/or transmission of information between the automation devices, and wherein
the automation device is adapted for directly sending an address to an automation device which submits a request.

45. The automation system according to claim 44, wherein the data transmission system is an Intranet and/or Internet.

46. The automation system according to claim 44, further comprising a device connected to the data transmission system for managing the addresses of the participating automation devices.
